(19) United States
(12) Patent Application Publication
(10) Pub. No.: US 2009/0063412 A1
(43) Pub. Date: Mar. 5, 2009

(54) Organizing and displaying stories by themes

(76) Inventors: Jonathan Harris, Brooklyn, NY (US); Upendra Shardanand, New York, NY (US)

Correspondence Address: KING & SPALDING, 1185 AVENUE OF THE AMERICAS, NEW YORK, NY, 10036-4003, US

(21) Appl. No.: 11/848,134

(22) Filed: Aug. 30, 2007

(51) Int. Cl. G06F 7/10

(52) U.S. Cl. 707/3; 707/102; 707/E17.108

(57) ABSTRACT

Stories are organized and displayed by themes. Theme names are created and topic names are chosen for the theme names. For each topic name, topic search strings are created. A database of stories is search for stories matching the topic search strings. At least some of the matching stories are displayed as a single web page. The single web page displays the matching stories according to themes and topic names.

### BACKGROUND

Online news sites such as http://abcnews.go.com, http://news.yahoo.com, http://news.google.com aggregate and display stories from all over the world. The main page on these and like websites typically display stories or articles according to general categories such as “World”, “Business”, “Technology”, “Science”, “Technology”, “Entertainment”, “Top Headlines”, “Money”, “Opinion”, “Politics”, “Travel”, “Sports”, “Most Popular”, and the like.

An Internet user reading a news site clicks on one of the general categories to view a web page with stories on that one general category. The web page displays the stories divided by more specific sub-categories. For example, a user selecting the general category “World” is brought to a page displaying stories which are separated into the following exemplary sub-categories: “Middle East”, “Europe”, “Latin America”, “Africa”, “U.S.”, “Asia”, and the like. In another example, a user selecting the general category “Business” is brought to a page displaying stories with are separated into the following exemplary sub-categories: “Economy”, “Stock Market”, “Personal Finance”, “Industries”, “Press Releases”, and the like.

A user may select any of these sub-categories to view stories in the sub-category. Typically, there are no sub-sub-categories. And, many times, a general category will not even have a sub-category; only a list of available stories is displayed without any type of even the most rudimentary indexing.

Oftentimes a user may find it more interesting to view stories having a particular theme, instead of stories belonging to a category. For example a user may be interested in viewing stories focusing on conflicts. The conflicts may comprise conflicts in the Middle East, and may comprise conflicts between the Vatican and religious groups, and may comprise other conflicts that are unrelated by category. In this example, Middle East conflicts may be fall in the general “World” category, and the Vatican conflicts may fall in the general “Politics” category.

There is currently no way for a user to instantly create web pages comprising stories according to theme. While a user could perform a search on the prior-art news sites according to a theme word, for example, “conflicts”, such searches yield an unorganized and unusable list of stories that merely have the word “conflicts” in the title or body of the story. Thus a need presently exists for a method for organizing and displaying stories by themes.

### SUMMARY

Stories are organized and displayed by themes. A database of stories is provided. A first theme name is created and a plurality of topic names is chosen for the first theme name. For each topic name, a topic search string is created, and for each topic search string, the database is search for stories matching the topic search string. Then, at least some of the matching stories are displayed as a single web page. In one embodiment, the matching stories are displayed according to topic names. In another embodiment, at least one more theme name is created. A plurality of topic names is chosen for the at least one more theme name, and for each topic name, a topic search string is created. Then, the database is searched for stories matching the topic search string and the matching stories are displayed as a single web page. In one embodiment, the matching stories are displayed as a theme table of contents page.

### BRIEF DESCRIPTION OF THE DRAWINGS

FIG. 1 is a prior art on-line news distribution system.

FIG. 2 is a method for organizing and displaying stories by themes.

FIG. 3 shows steps of creating additional themes.

FIG. 4 shows steps of displaying a single web page as a theme page.

FIG. 5 shows a theme page with the matching stories displayed according to topic names.

FIG. 6 shows additional steps for creating a different theme page.

FIG. 7 shows steps of displaying a single web page as a theme table of contents page.

FIG. 8A-C shows a theme table of contents page with the matching stories displayed according to theme names.

FIG. 9 shows another exemplary theme table of contents page with the matching stories displayed according to theme names.

FIG. 10 shows an alternate theme table of content page with the matching stories displayed according to theme name and time.

FIG. 11 shows a system for organizing and displaying stories by themes.

### DETAILED DESCRIPTION OF THE PRESENTLY PREFERRED EMBODIMENTS

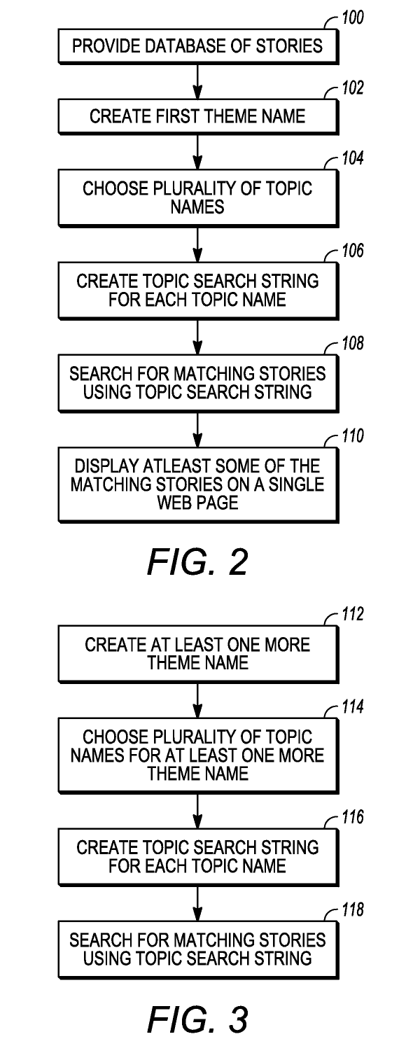

FIG. 2 shows a method for organizing and displaying stories by themes. Briefly, a database of stories is provided (step 100), a first theme name is created (step 102), and a plurality of topic names is chosen for the first theme name (step 104). Next, a topic search string is created for each topic name (step 106). Then, for each topic search string, the database is searched for stories matching the topic search string (step 108). And, the matching stories are displayed on a single web page (step 110).

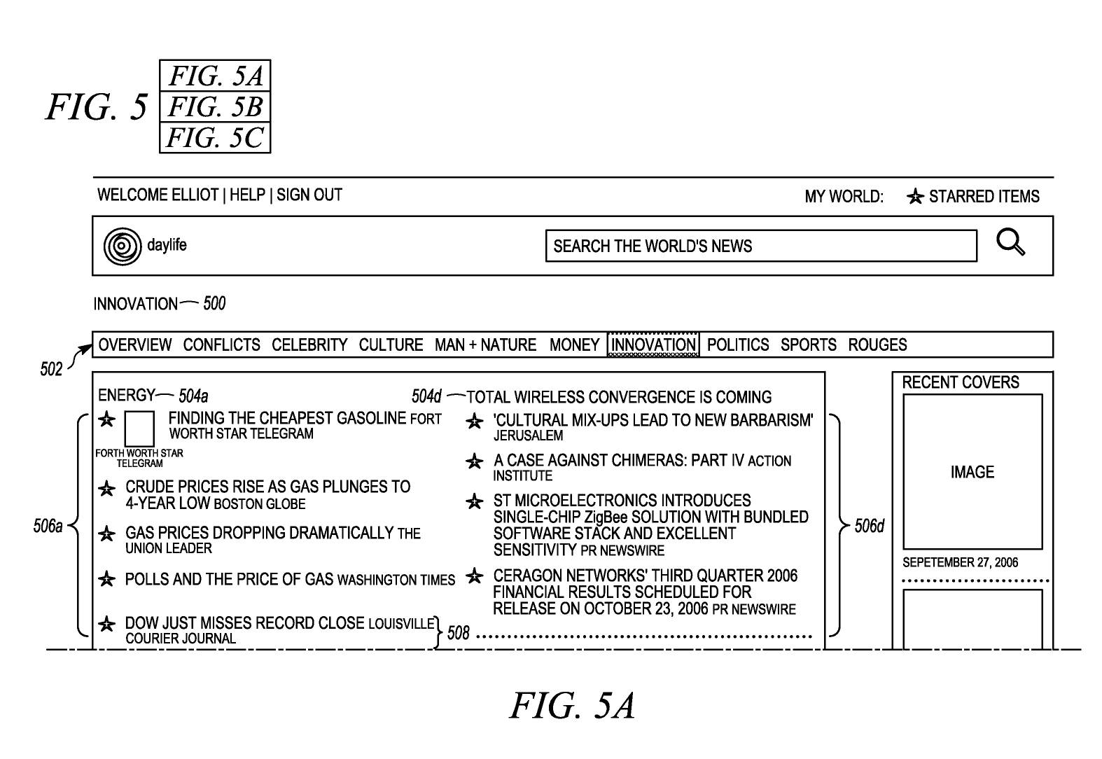

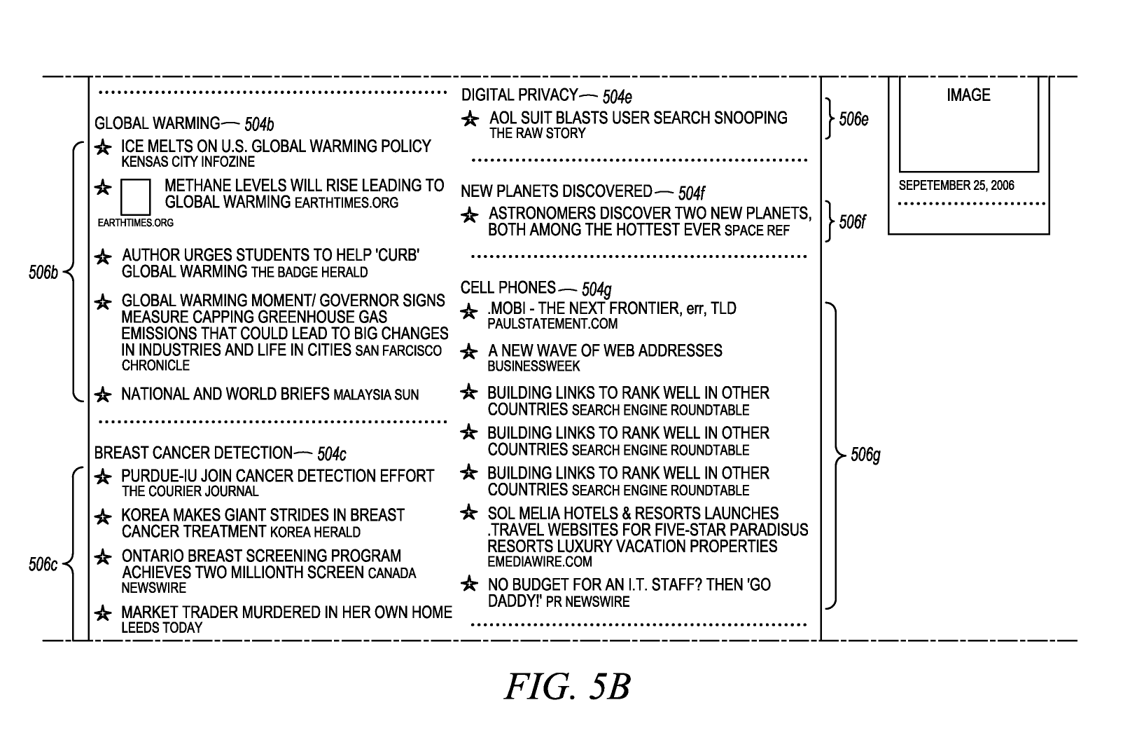

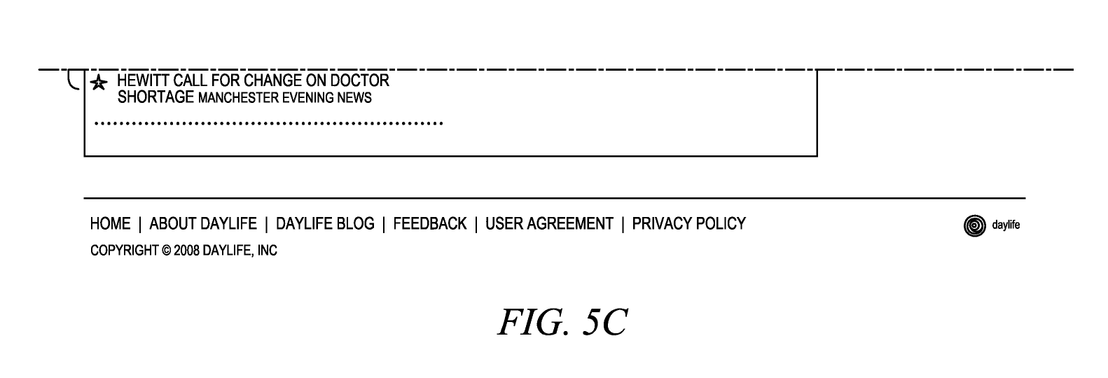

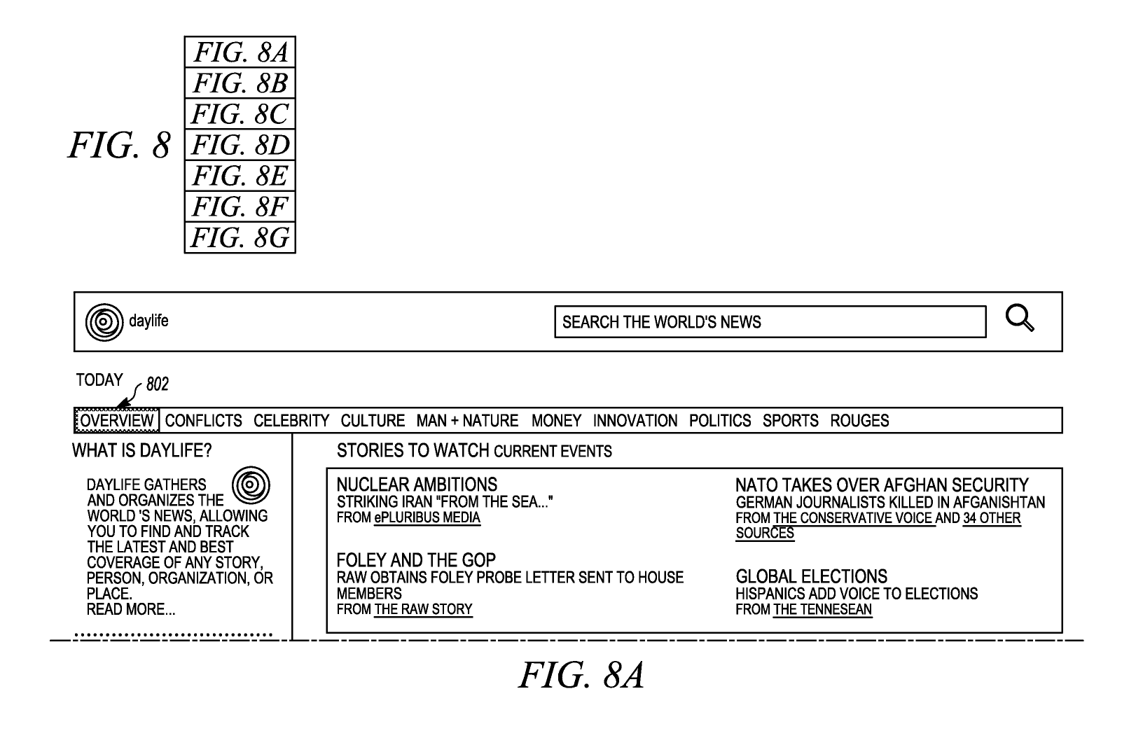

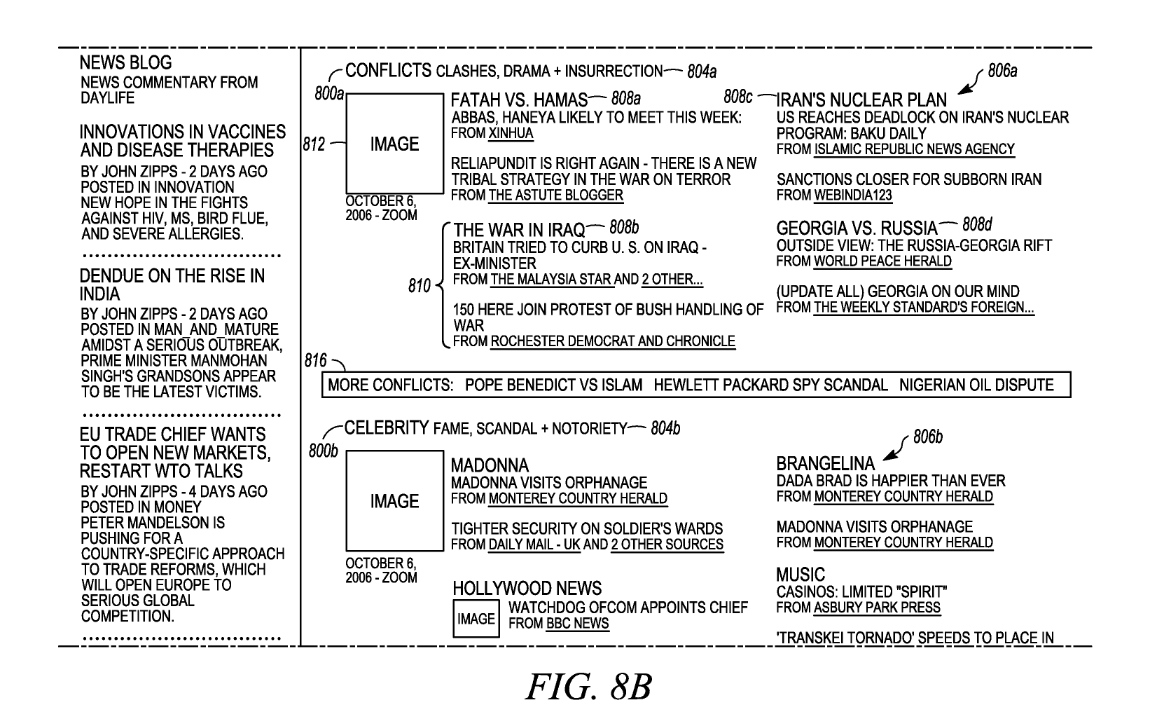

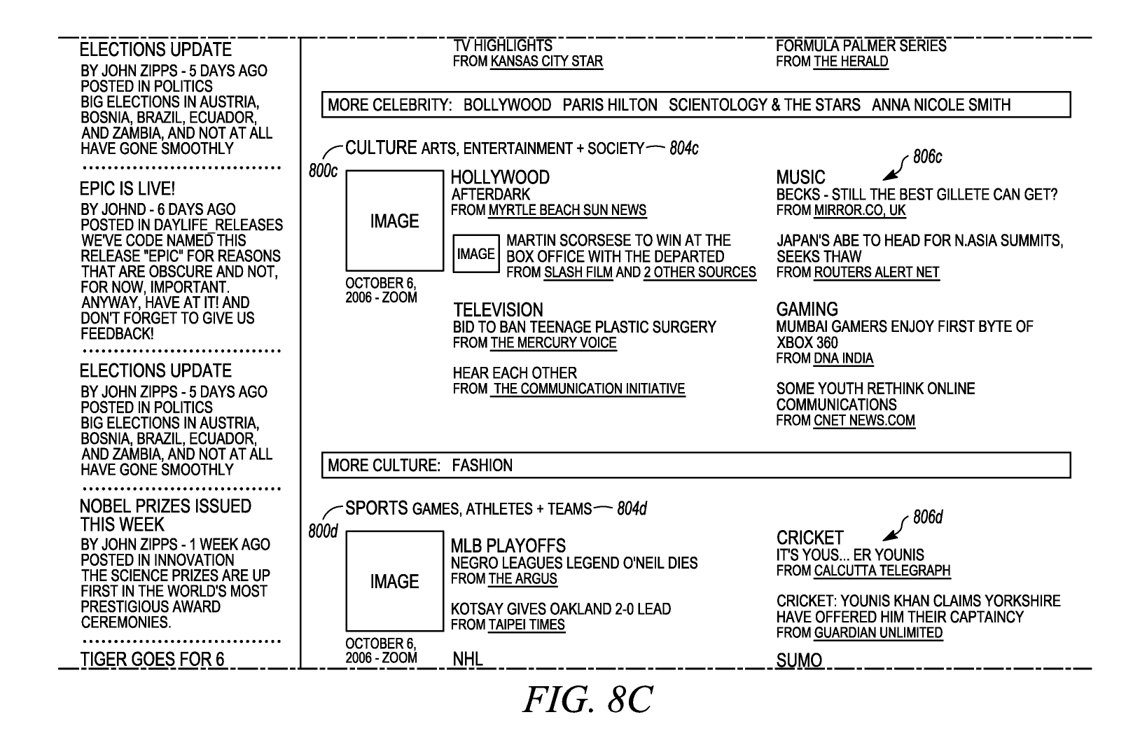

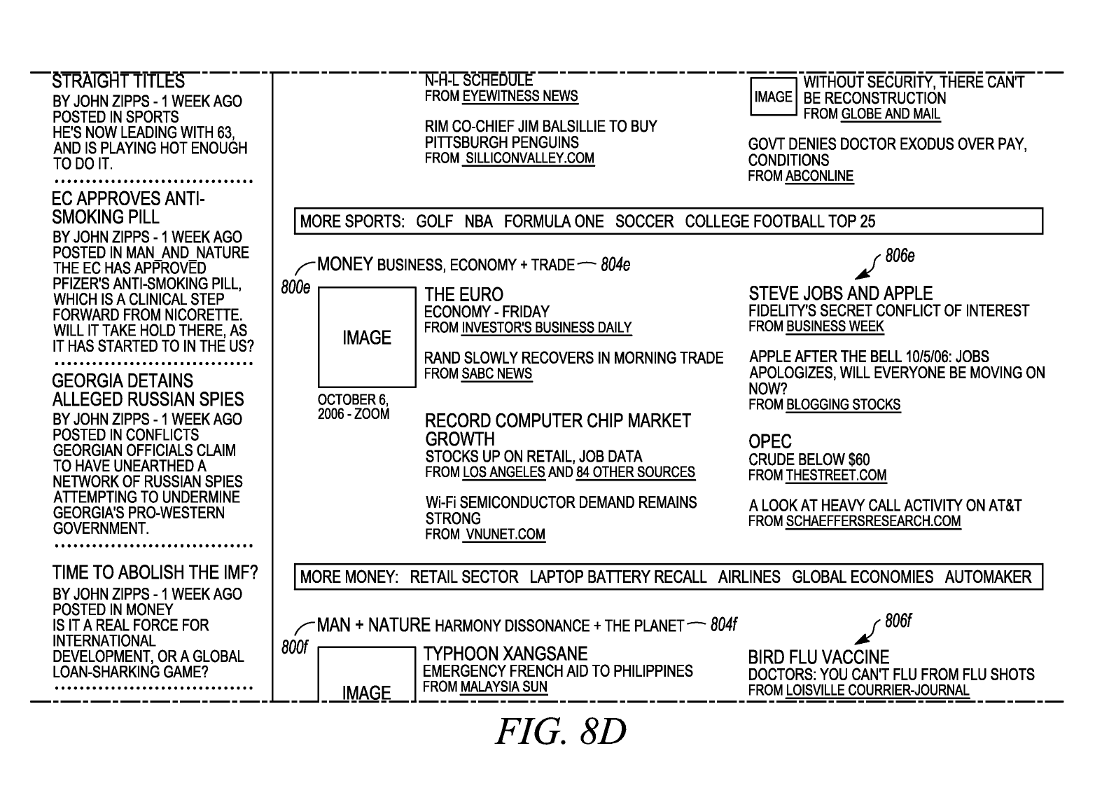

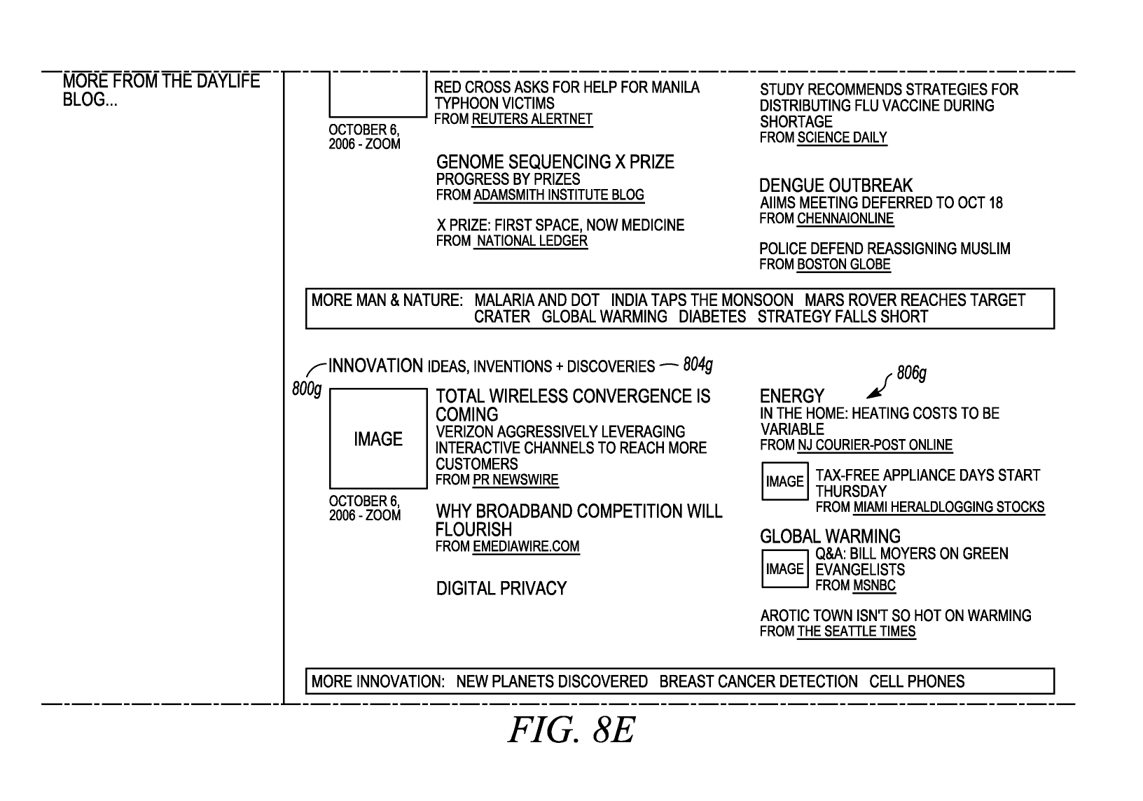

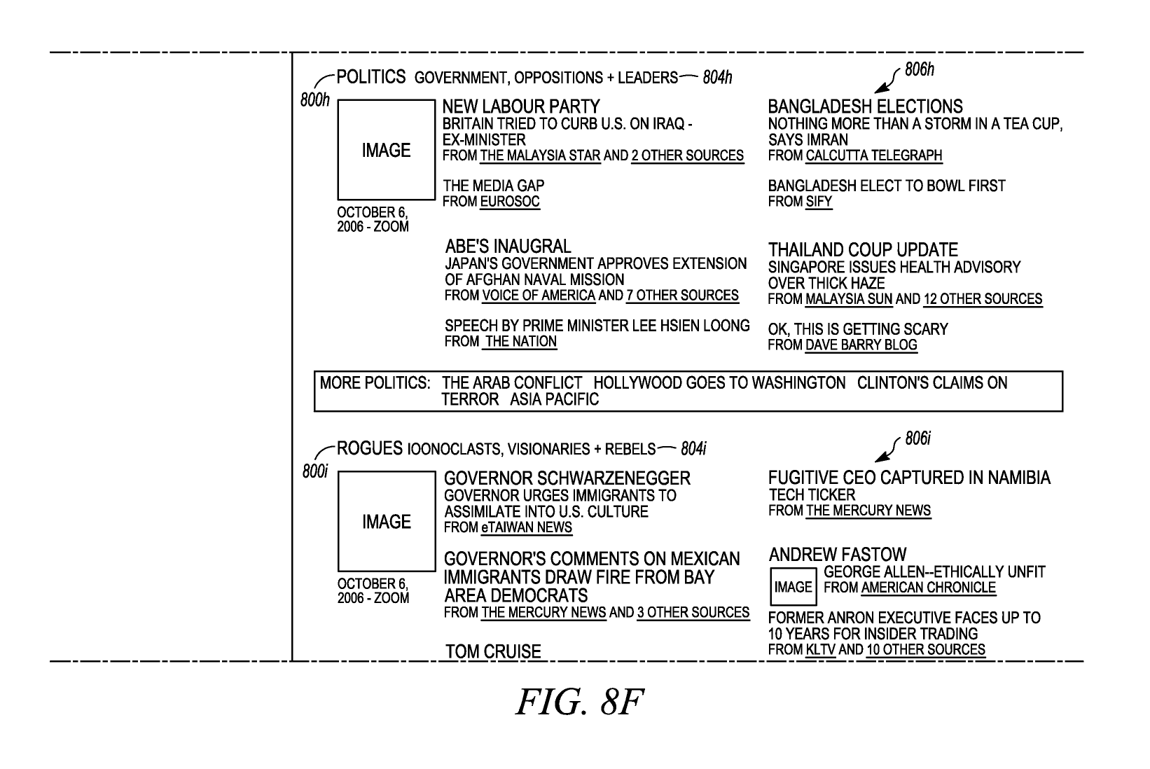

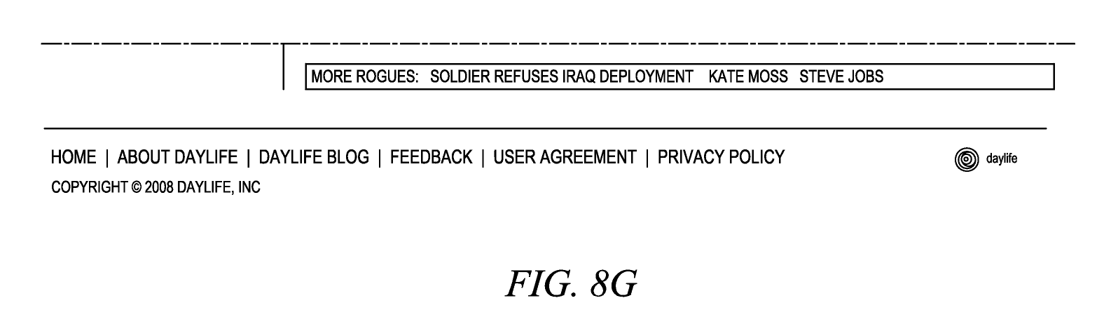

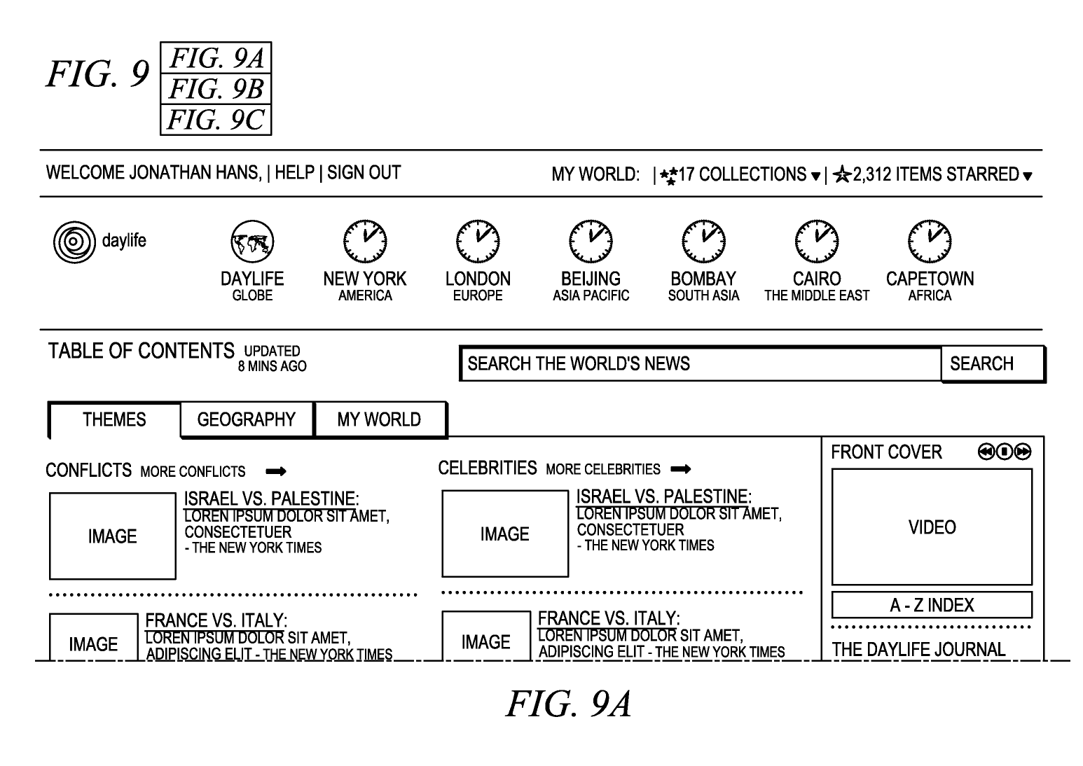

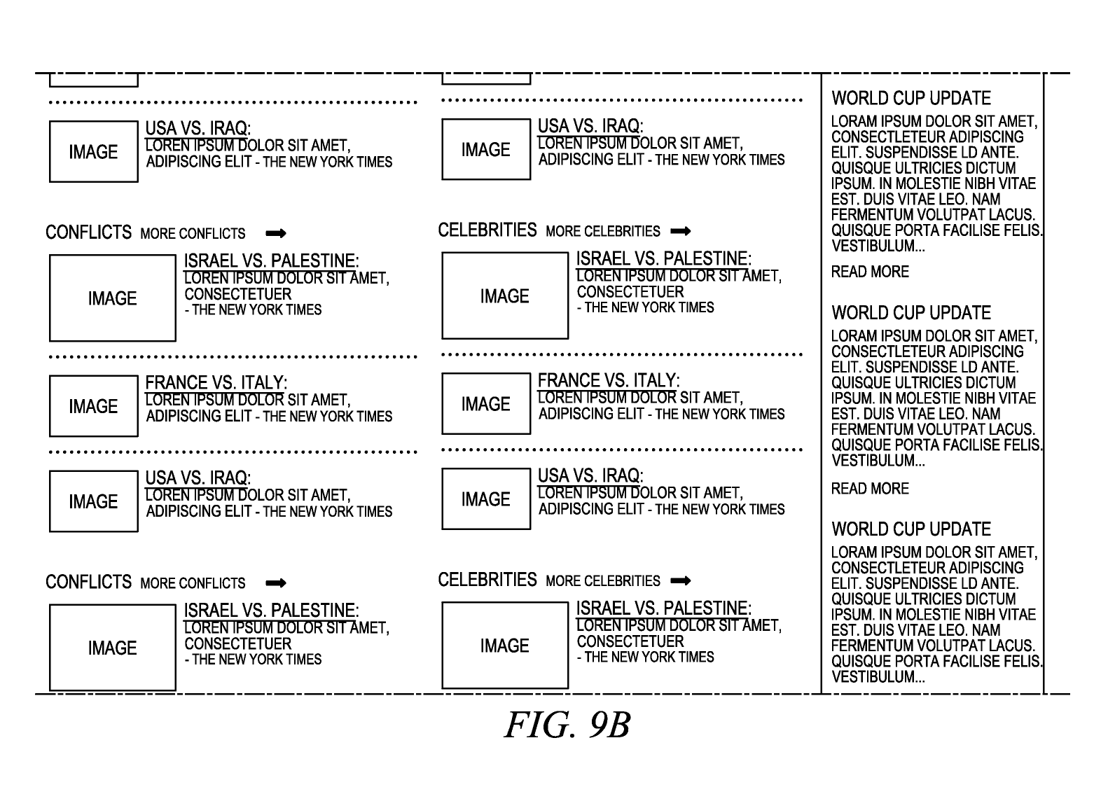

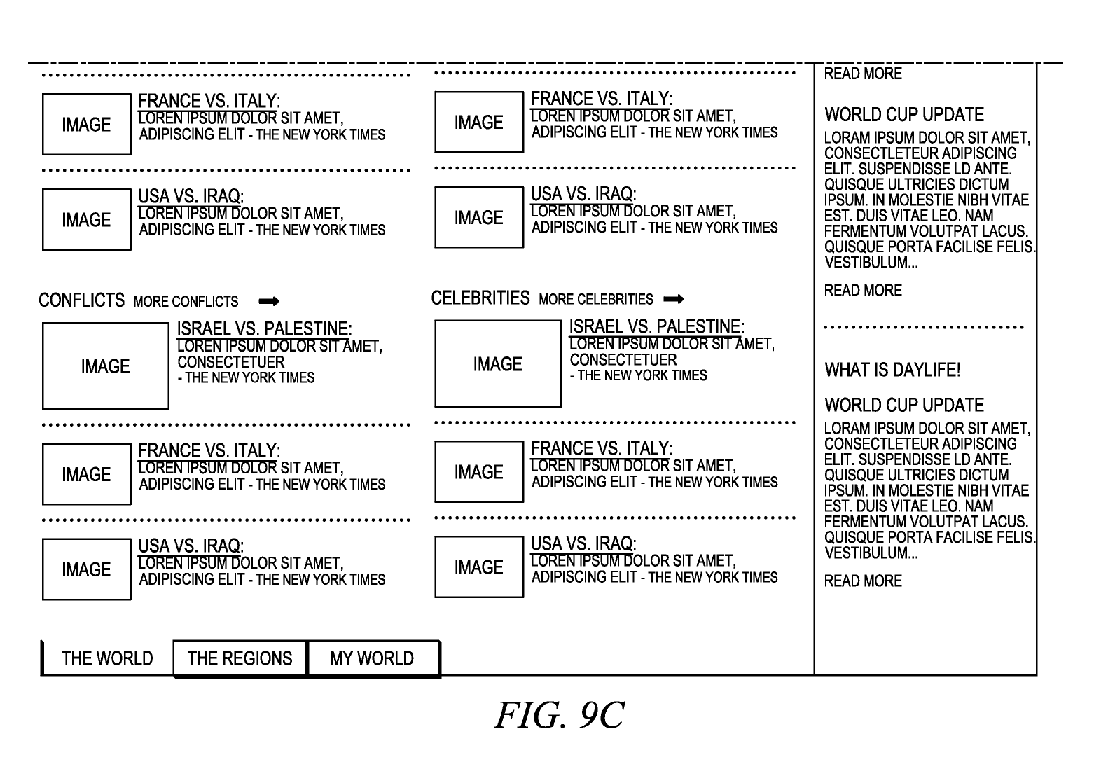

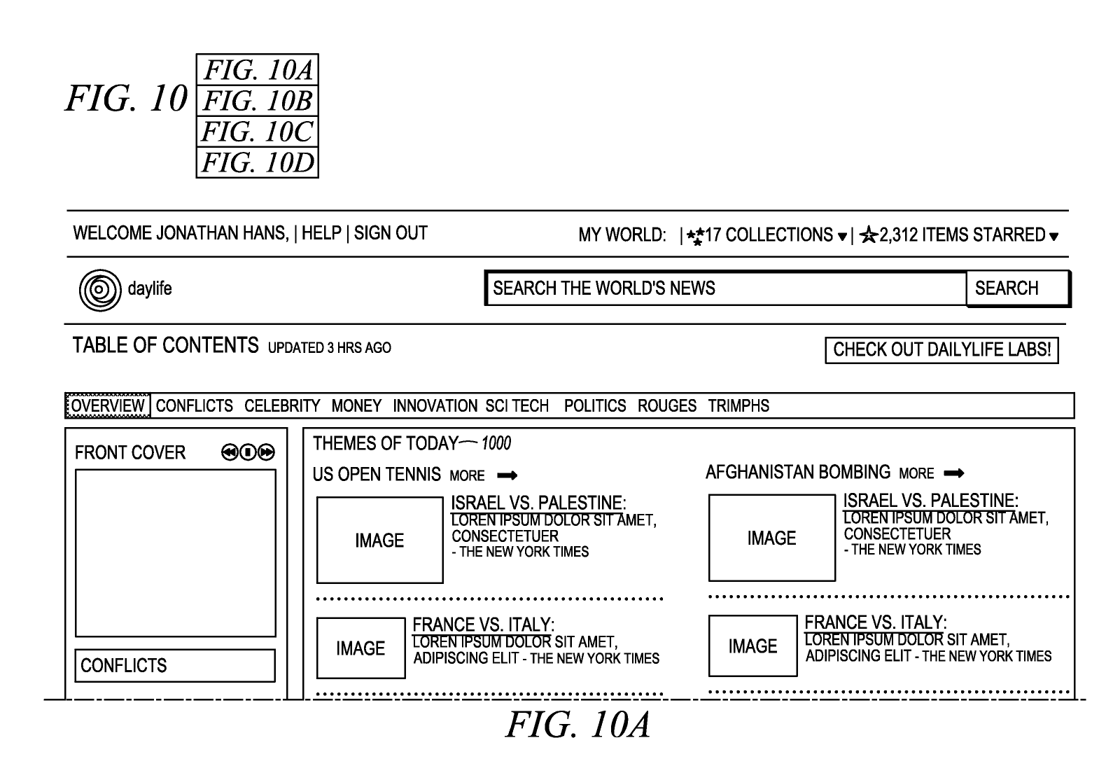

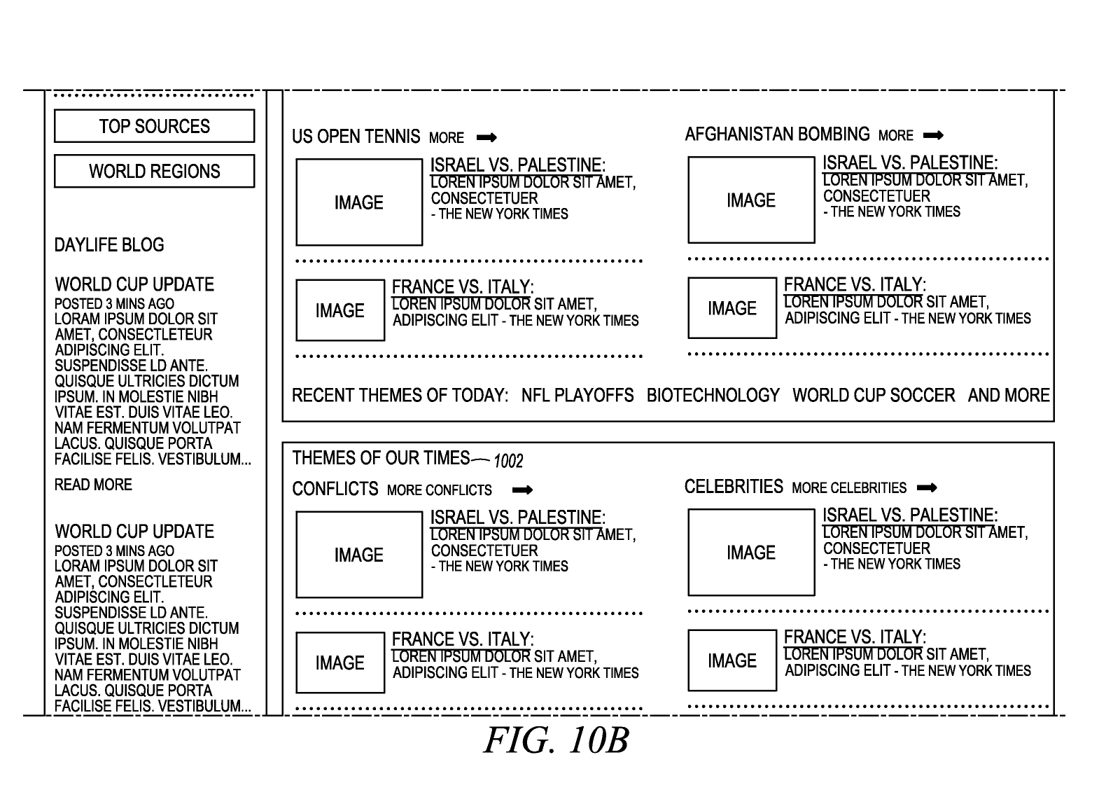

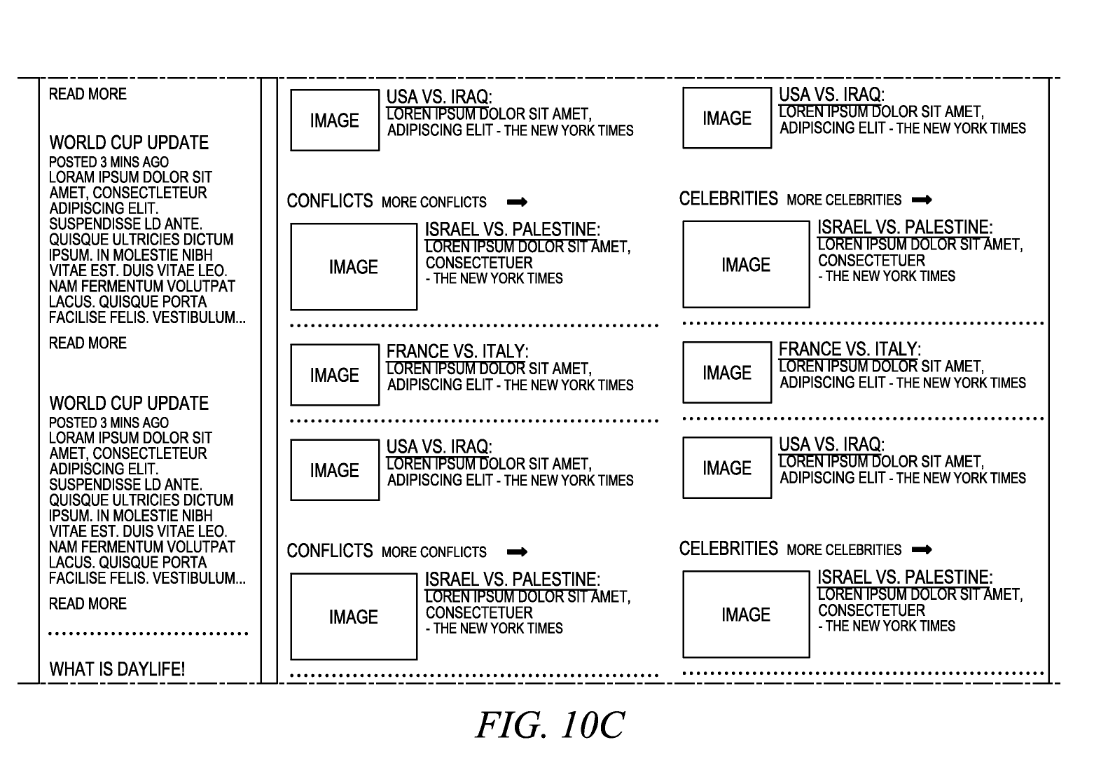

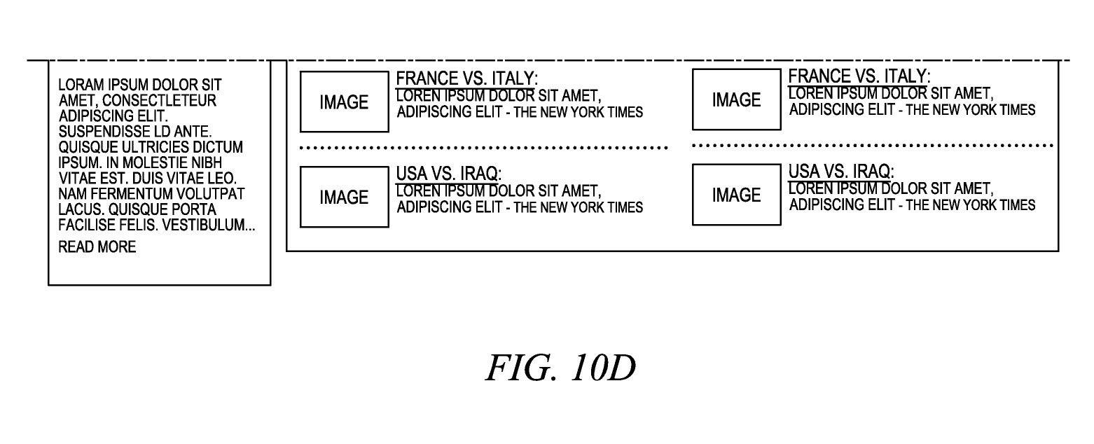

As will be disclosed, the matching stories are displayed on the single web page in various forms. Some of the forms which will be discussed in detail are shown in FIGS. 5, 8, 9, and 10. FIG. 5 shows a theme page with the matching stories displayed according to topic names. FIG. 8 shows a theme table of contents page with the matching stories displayed according to theme names. FIG. 9 shows another theme table of contents page with the matching stories displayed according to theme names. FIG. 10 shows an alternate theme table of content page with the matching stories displayed according to theme name and time.

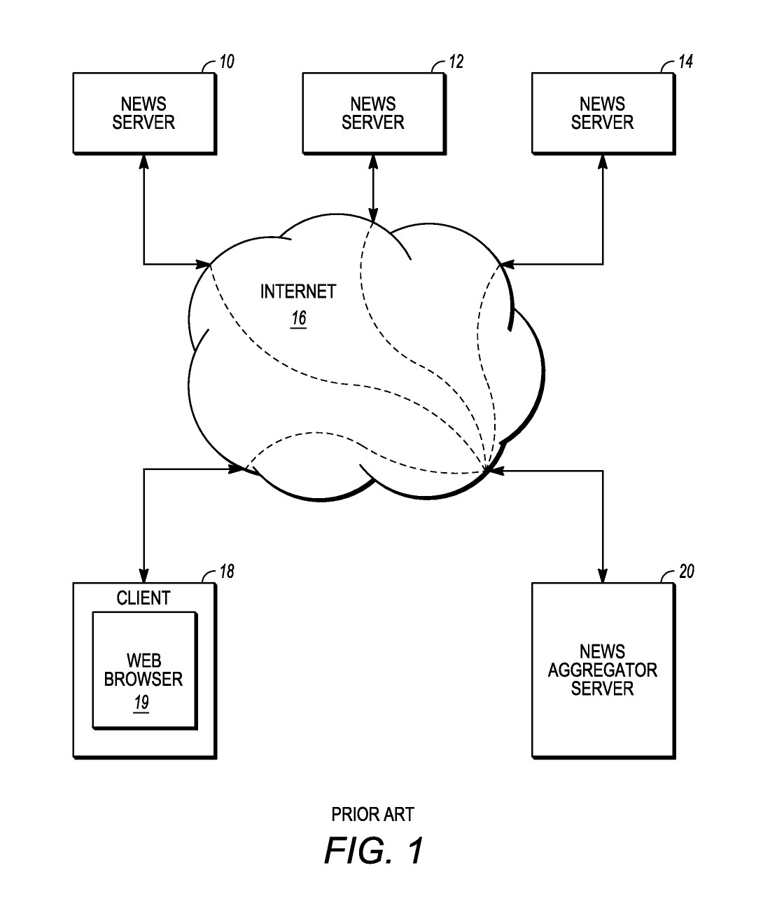

Before proceeding, as a matter of background, FIG. 1 shows an exemplary prior-art system for on-line news distribution, client computer 18 is connected to the Internet 16 and a user reads articles displayed on web browser 19. Articles are delivered to client computer 18 by Internet connected news servers 10, 12, and/or 14. A story may comprise one or more article.

The articles comprise text and may further comprise an image or images, links to audio and video, embedded audio and video, links to other articles, links to web pages and blogs, other embeddable or web readable or executable content, and the like. As used herein, the terms “web browser content” or “content” are understood to mean, either by themselves or in combination, text, an image or images, links to audio and video, embedded audio and video, links to other articles, links to web pages and blogs, and other types of content that are displayable or accessible in a web browser.

There may be many more news servers than what is shown. As is well known, articles are displayed in web browser 19 simply by typing in the web address, (universal resource locator or universal resource identifier) of any of the news servers 10, 12, or 14. News servers such as 10, 12, and 14 may supply news from sources such as Agence France-Press (AFP), Reuters, Associated Press (AP), Los Angeles Times, New York Times, USA Today, National Public Radio (NPR), CNN.com, Slashdot.org and thousands of other online local, regional, national, and international news outlets.

There are many other websites where Internet users can receive news, such as Yahoo! News (http://news.yahoo.com) and Google News (http://news.google.com). While these, and like websites do not typically generate any original news content, they do provide a convenient way for Internet users to view articles from a multiplicity of sources. For example, Internet connected news aggregator server 20 receives articles from news servers 10, 12, and 14. Client computer 18 connects to news aggregator server 20, and may optionally connect directly to any other news server connected to the Internet.

Regardless of the source of the article, the web pages comprising the articles may be manipulated using well known and widely practiced methods. For example, pages and any content of the pages and structure of the pages, are accessible, readable, parseable, modifiable and the like, by any conventional means such as application programming interfaces (API) like the Document Object Models (DOM), or other various well know methods of accessing, reading, parsing, modifying, processing, and the like, of HTML, XHTML, XML, and other web readable or executable code, scripts, languages, and the like.

Thus, it is a well known matter to access any of the news servers, including news aggregator servers, to create a database of stories, and to continually update the database of stories. Of course, there are many novel ways to organize, link, structure, and query records in the database of stories, but the fundamental methods and systems for the creation of a database of stories is well known in the art.

So, referring back to FIG. 2, a database of stories is provided (step 100). Next, a first theme name is created (step 102). Some exemplary theme names include Conflicts, Celebrity, Culture, Man+Nature, Innovation, and Rogues. It is of particular note that a theme is vastly different from categories described above with reference to the prior art. A category is a specific classificatory division. Among a pool of news articles, it is easy to divide them according to their categories, such as Science or Business. A theme on the other hand represents a dominant idea, and may comprise articles having many different categories. For example, Rogues is a theme and may comprise articles from categories such as Money, Business, and Entertainment, with the dominant idea being that newsmakers in the articles are mischievous, dishonest, deceitful, corrupt, quirky or peculiar in some way. A newsmaker is a person, place, or thing mentioned in an article.

Once the first theme name is created, a plurality of topic names are chosen for the first theme (step 104). Topic names subdivide a theme and represent different subjects within the theme. For example, the theme Innovation may have the topic names Energy, Global Warming, Breast Cancer Detection, Wireless Convergence, Digital Privacy, New Planets, and Cell Phones.

Within a theme, the topic names can change over time, that is, topic names can be removed and added. Oftentimes, topic names may be added or removed based on current events. For example, the theme Rogues may have topic names Soldier Refuses Iraq Deployment, Donald Rumsfeld, and Governor Schwarzenegger one month, and Steve Jobs, Senate Republicans, and The Mafia another month. So, topic names are dynamic and may be, for example and without limitation, the name of a person, organization, an item in the popular culture, a subject of interest, a concept, or any other combination.

The following comprises exemplary topic names for some exemplary themes for one moment in time around October 2006:

| Theme Name | Topic Names |
|---|---|
| Conflicts | Fatah vs. Hamas, Iran's Nuclear Plans, The War in Iraq, Georgia vs. |
| | Russia, Pope Benedict vs Islam, Hewlett Packard Spy Scandal, |
| | Nigerian Oil Dispute, Sudan Crisis |
| Celebrity | Madonna, Brangelina, Hollywood News, Music, Bollywood, Paris |
| | Hilton, Scientology & The Stars, Anna Nicole Smith |
| Culture | Music & Movies, Television, Gaming, Fashion |
| Man + Nature | Typhoon Xangsane, Bird Flu Vaccine, Genome Sequencing X Prize, |
| | Dengue Outbreak, Malaria and DDT, India Taps the Monsoon, Mars |
| | Rover Reaches Target Crater, Global Warming, Diabetes Strategy |
| | Falls Short |
| Money | The Euro, Steve Jobs & Apple, Record Computer Chip Market |
| | Growth, OPEC, Retail Sector, Airlines, Global Economies, |
| | Automaker Alliance |
| Innovation | Total Wireless Convergence Is Coming, Energy, Digital Privacy, |
| | Global Warming, New Planets Discovered, Breast Cancer Detection, |
| | Cell Phones |
| Politics | New Labour Party, Bangladesh Elections, Abe's Inaugural, Thailand |
| | Coup Update, The Arab Conflict, Hollywood Goes To Washington, |
| | Clinton's Claims On Terror, Asia Pacific |
| Sports | MLB Playoffs, NASCAR, College Football Top 25, SUMO, Golf, |
| | NBA, Formula One, Soccer, Cricket |
| Rogues | Governor Schwarzenegger, Fugitive CEO Captured in Namibia, Tom |
| | Cruise, Andrew Fastow, Soldier Refuses Iraq Deployment, Kate Moss, |
| | Steve Jobs |

Turning back to FIG. 2, topic names are chosen for the first theme (step 104) as described above, and then, for each topic name a topic search string is created (step 106). The topic search string may comprise any number of terms, operators, wildcards, and the like. The topic search string is formatted in any number of ways to be compatible with searching the database of stories. Machine learning techniques, such as Bayesian and k-nearest neighbor classifiers may be used for topics and themes. Creating search strings with the proper syntax, and searching or querying databases is well understood by those of ordinary skill in the art.

Since each topic search string represents a topic name, and a topic name represents a subject within the theme, a topic search string combines many terms in such a way as to represent a subject in aggregate. Typically, the topic search stings comprises many terms and many Boolean operators such as AND, OR, NOR, XOR, NOT, NAND and the like. The topic search string may also comprise special characters for representing characters such as a space, a double quote, a single quote, parenthesis, and the like.

The following comprises some exemplary topic search strings for some exemplary topic names for some exemplary themes for one moment in time around October 2006:

| Theme Name | Topic Name | Topic Search String |
|---|---|---|
| Conflicts | Pope Benedict vs Islam | search?q=%22pope+benedict%22++OR+% |
| | | 22rosa+sgorbati%22+OR+Islam |
| | Hewlett Packard Spy | search?q=%22Mark+Hurd%22+OR+%22Patricia |
| | Scandal | +C.+Dunn%22+or+%22carly+fiorina |
| | | %22 |
| Celebrity | Music | search?q=avril+OR+tricky+OR+timberlake |
| | | +OR+%22willie+nelson%22+OR+chesney |
| | Scientology & the Stars | search?q=scientology+AND+cruise+OR+foley |
| | | +OR+beck+OR+travolta |
| Culture | Fashion | search?q=%22paris+fashion+show%22+OR |
| | | +%22skinny+model%22 |
| | Gaming | search?q=%22Tokyo+Game+Show%22+OR |
| | | +%22PlayStation+3%22+OR+%22Sony+ |
| | | Playstation%22+OR+%22xbox+360%22 |
| Man + Nature | Bird Flu Vaccine | search?q=%22bird+flu%22+vaccine |
| Money | Steve Jobs & Apple | search?q=apple+jobs+option+backdating |
| | Global Economies | search?q=EU+OR+%22bulgaria%22+OR+ |
| | | %22romania%22++OR+%22Prime+Minister |
| | | +Shinzo+Abe%22+OR+%22japan+economy |
| | | %22 |
| Innovation | Energy | search?q=%22power+supply+standard%22 |
| | | +OR+%22Ecos+Consulting%22+OR+%22 |
| | | Honda+Diesel+Engine%22+OR+%22diesel |
| | | +powertrain+%22+OR+%22Energy+Information |
| | | +Administration%22 |
| | Global Warming | search?q=%27%22Goddard+Institute+for+ |
| | | Space+Studies%22++OR++%22James+Hansen |
| | | %22+OR+%22Global+Warming%22 |
| Politics | Asia Pacific | search?q=%22Premier+Wen+Jiabao%22+OR |
| | | +%22Prime+Minister+Shinzo+Abe%22+ |
| | | OR+%22Sino- |
| | | Japanese+relations%22+OR+%22Chinese+ |
| | | President+Hu+Jintao%22+OR+%22Koji+Omi |
| | | %22++OR+%22Chief+Cabinet+Secretary |
| | | +Yasuhisa+Shiozaki+%22 |
| Sports | Cricket | search?q=%22younis+khan%22+OR+%22International |
| | | +Cricket+Council%22+OR+%22 |
| | | mark+thomas%22++OR+%22Pakistan+Cricket |
| | | +Board%22 |
| Rogues | Tom Cruise | search?q=%22tom+cruise%22+crazy |
| | Soldier Refuses Iraq | search?q=%28%22Fort+Lewis%22+soldier |
| | Deployment | +refuse+deploy%29+OR+%22Fort+Lewis |
| | | %22 |

The database of stories is searched for stories matching the each of the topic search strings (step 108). The search may be performed at periodic intervals or as articles arrive. Then a single web page is displayed with at least some of the matching stories (step 110). In one embodiment, the database of stories is stored on an Internet connected server accessible remotely via a Universal Resource Identifier (URI) and the topic search string is part of the Universal Resource Identifier, such as http://www.storiesdatabase.com/search?q= . . . The database is searched (step 108) by applying the URI to the database, and the single web page is displayed in web browser on a remote Internet connect client computer.

The steps shown in FIG. 2 disclose a method for one theme, that is, the first theme (step 102). As shown above, there may be themes in addition to the first theme. FIG. 3 shows the steps of creating the additional themes. Examining FIG. 3, the steps in addition to those already disclosed, include creating at least one more theme name (step 112), and choosing a plurality of topic names for the at least one more theme name (step 114). Continuing, a topic search string is created for each topic name (step 116), and the database is searched for stories matching each topic search string (step 118). These steps are analogous to steps 102, 104, 106, and 108 disclosed above with reference to the first theme of FIG. 2.

With this in mind, a first theme with corresponding topics is created and the database searched, along with one more theme, for example, a second theme, a third theme, and so on. It follows then that the single web page displayed in step 110 may include some or all, in a plurality of combinations, of theme names, topic names, and matching stories.

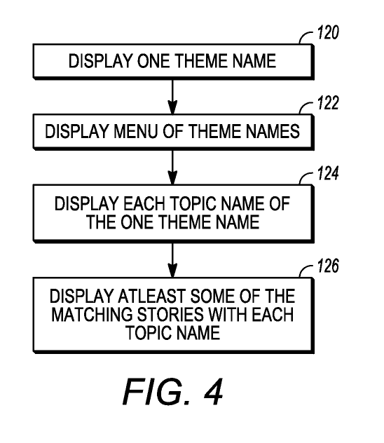

One exemplary embodiment of the single web page is the theme page shown in FIG. 5. FIG. 5 shows a theme page with the matching stories displayed according to the plurality of topic names. Recall, the plurality of topic names were created in step 104 of FIG. 2 and the matching stories searched for in step 108. FIG. 4 shows the steps of displaying the single web page as a theme page, that is, according to the plurality of themes.

With reference to FIG. 4 and FIG. 5, the steps of displaying the single web page includes displaying one of the theme names (step 120). Here, one theme name of the multiplicity of theme names is displayed. The multiplicity of theme names includes the first theme name and the at least one more theme name. So, one of the first theme name and the at least one more theme name is displayed. In the exemplary embodiment of FIG. 5, the one theme name 500 displayed is INNOVATION.

The step of displaying the single web page also includes displaying a menu of theme names (step 122). The menu of theme names includes the first theme name and the at least one more theme name. In the exemplary embodiment of FIG. 5, the menu of theme names 502 includes theme names CONFLICTS, CELEBRITY, CULTURE, MAN+NATURE, MONEY, INNOVATION, POLITICS, SPORTS, AND ROGUES. The menu may also include other items such as OVERVIEW.

Continuing, the step of the displaying the single web page also includes displaying topic names and matching stories. That is, for each topic name of the one theme name from step 120, the topic name of each topic is displayed (step 124) and, with each topic name, at least some of the matching stories are displayed (step 126). In the exemplary embodiment of FIG. 5, the topic names of each topic 504 displayed is Energy 504a, Global Warming 504b, Breast Cancer Detection 504c, Total Wireless Convergence Is Coming 504d, Digital Privacy 504e, New Planets Discovers 504f, and Cell Phones 504g. Also, at least some of the matching stories displayed 506 with each topic are matching stories 506a for the topic name Energy 504a, matching stories 506b for the topic name Global Warming 504b, matching stories 506c for the topic name Breast Cancer Detection 504c, matching stories 506d for the topic name Total Wireless Convergence Is Coming 504d, matching story 506e for the topic name Digital Privacy 504e, matching story 506f for the topic name New Planets Discovered step 504f, and matching stories 506g for the topic name Cell Phones 504g.

As disclosed in FIG. 5, the at least some of the matching stories displayed are displayed according to topic, that is, each topic name 504 is displayed with the matching stories 506 belonging to each topic name displayed under it. The topic names and matching stories may be displayed in varying colors, formats, fonts, sizes, font weights, and like to achieve a pleasing and readable layout.

In this example, a maximum of five matching stories per topic name is displayed, however a greater or fewer number may be displayed. The order of the matching stories may be displayed in many ways such as alphabetically, randomly, or other ways such as according to a relevancy ranking or similar metric. Relevancy rankings for matching records in database searches are well understood by those of ordinary skill in the art.

So, in this example, displaying at least some of the matching stories (110 of FIG. 2) means displaying the theme name, a menu, and at least some elements of each matching stories. The elements comprising a story or article were described above. For example, in this example, referring to exemplary matching story 508, displaying a story includes displaying the title of the story (“Dow just misses record close”), and displaying the source of the story (“Louisville Courier-Journal”).

Other elements comprising the story could also be displayed, such as a summary, abstract, or section of the story, the author, the publisher, a thumbnail image of the story, and any other content related to the story. Also, displaying a story may also include displaying a number of sources or alternate sources for the story.

The elements displayed on the single web page may also include displaying the elements as an embedded link. In this embodiment, anything displayed, for example the theme name Energy 504a, may also include an embedded link which when clicked on creates a web page displaying more the matching stories for topic name Energy 504a. In this way, a user can view a theme page (FIG. 5) and then explore any of the topic names 504 in greater detail with the click of a mouse.

In another example, displaying the matching story, in the case of FIG. 5 displaying a title and source, also includes displaying embedded links for each title and each source. Clicking on the title displays the actual article, and clicking on the source displays articles only from that source.

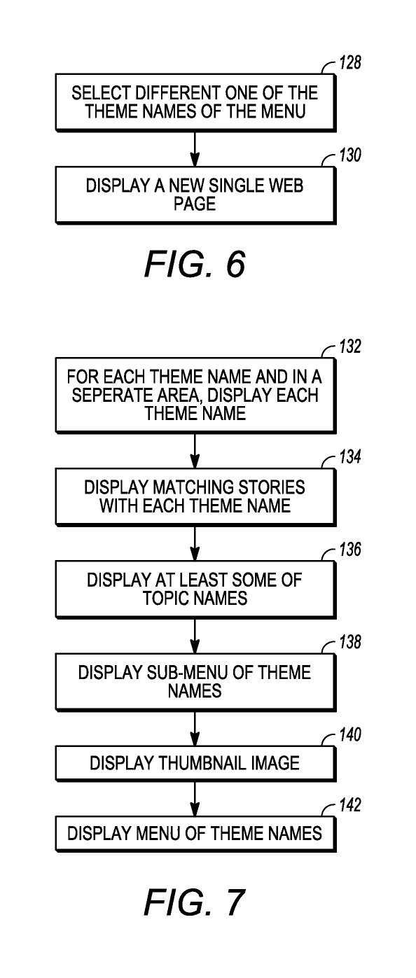

Also, the menu 502 may include embedded links for the menu items so that a user can click on any of the menu items and instantly create a different theme page. Referring to FIG. 6, the steps for displaying an different theme page are shown. A different one of the theme names of the menu (which was displayed in step 122 of FIG. 4) is selected (step 128), and for the selected theme name, a new single web page is displayed (step 130) by repeating the steps of displaying the one theme name (step 120), displaying the menu of theme names (step 122), displaying the topic name (step 124), and displaying with each topic name (step 126).

In addition to a theme page, other single web pages are possible. Another exemplary embodiment of the single web page is a theme table of contents page shown in FIG. 8. For illustration purposes, FIG. 8 is divided into three pages, FIG. 8A, FIG. 8B, and FIG. 8C. It is understood however, that when displayed in a web browser on a computer, FIG. 8A-C is actually one contiguous web page, rather than three separate web pages. In this exemplary embodiment the matching stories are displaying according to the multiplicity of theme names, that is, according to the first theme name and the at least one more theme name. FIG. 7 shows steps of displaying the single web page as a theme table of contents page.

As disclosed in the exemplary single web page of FIG. 8, the theme table of contents page includes many of the elements disclosed above with reference to FIG. 5. With reference to FIG. 7, the steps of displaying the single web page includes displaying each theme name (step 132). That is, for each of the first them name and at least one more theme name, each theme name is displayed. Further, each theme name is displayed in a separate area of the single web page. Displaying in a separate area sets apart the themes visually from one another. In the exemplary embodiment of FIG. 8, each theme name displayed is CONFLICTS 800a, CELBRITY 800b, CULTURE 800c, SPORTS 800d, MONEY 800e, MAN+NATURE 800f, INNOVATION 800g, POLITICS 800h, and ROGUES 800i.

The displaying further includes, displaying at lease some of the matching stories with each theme name (step 134). In the exemplary embodiment of FIG. 8, at least some of the stories displayed are indicated by labels 806a-i. As can be seen, the matching stories are displayed with their corresponding theme names.

Examining CONFLICTS 800a theme and matching stories 806a, displaying the stories includes displaying at least some of the topic names (step 136). The topic names 808 displayed include exemplary topic names Fatah vs. Hamas 808a, The War in Iraq 808b, Iran's Nuclear Program 808c, and Georgia vs. Russia 808d. Examining topic name The War in Iraq 808b, the displaying further includes displaying a title, a source and a number of sources. Displaying at least some of the topic names (step 136) may also include displaying topic names 804 next to theme name 800.

The displaying may also include displaying a sub-menu of theme names (step 138) as shown by exemplary sub-menu 816. The displaying may also include displaying a thumbnail image (step 140) as shown by exemplary thumbnail image 812. The displaying may also include displaying the menu 802 of themes names (step 142).

As disclosed with reference to FIG. 5, any of the elements displayed may be displayed as an embedded links. For example, clicking on theme name INNOVATION 800g may display the theme page of FIG. 5. Those skilled in the art that many other single web pages may be displayed. FIG. 9 shows another exemplary theme table of contents page with the matching stories displayed according to theme names. FIG. 10 shows an alternate theme table of content page with the matching stories displayed according to theme name and time. In particular, FIG. 10 displays theme names, topic names, matching stories, and the like as described above, but further displays these elements according to date. For example, in one area of the single web page only those elements from the current day are displayed, THEMES OF TODAY 1000. And, in another area of the single web page elements from, for example, the last two weeks are displayed THEMES OF OUR TIMES 1002. The single web page may similarly be displayed according to geography, or region of the work, and the like.

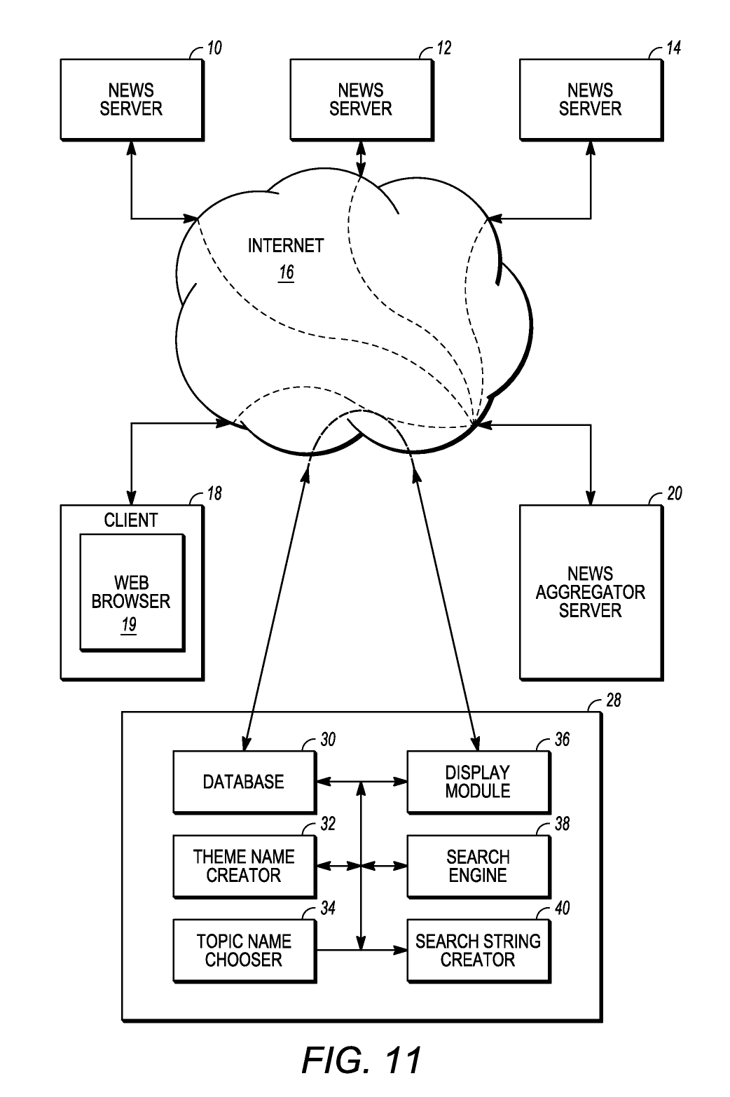

With the above disclosure in mind, FIG. 11 shows a system for organizing and displaying stories by themes 28. The system comprises a database of stories 30, a theme name creator module 32, a topic name chooser module 34, a search string creator module 40, a search engine module 38, and a display module 36. The database 30 comprises stories available from servers 10, 12, 14, 20 accessible over the Internet 16. Themes are created with them name creator module 32. Topic names are chosen with topic name chooser module 34. Search strings are created with search string creator module 40. The database is searched for matching stories with search engine module 38, and the single web page is displayed with display module 36. These modules execute the methods described above.

Finally, the disclosed systems and methods, and modification thereof may be implemented on any conventional computer using any array of widely available and well understood software platforms, programs, and programming languages. For example, in one embodiment, the systems and methods are implemented on an Intel or Intel compatible based computer running a version of the Linux operation system. The databases are MySQL databases. Various computer and scripting languages are used such as PHP, Python, Perl, Java, Javascript, HTML, XML, and the like.

The foregoing detailed description has discussed only a few of the many forms that this invention can take. It is intended that the foregoing detailed description be understood as an illustration of selected forms that the invention can take and not as a definition of the invention. It is only the following claims, including all equivalents, that are intended to define the scope of this invention.

What is claimed is:

1. A method for organizing and displaying stories by themes comprising the steps of:
providing a database of stories;
creating a first theme name;
choosing a plurality of topic names for the first theme name;
for each topic name, creating a topic search string;
for each topic search string, searching for stories in the database matching the topic search string; and
displaying at least some of the matching stories as a single web page.

2. The method of claim 1 wherein said step of displaying further comprises displaying according to at least one of the following: the plurality of topic names, a date, a range of dates, and a geographical location.

3. The method of claim 1 further comprising:
creating at least one more theme name;
choosing a plurality of topic names for the at least one more theme name;
for each topic name, creating a topic search string; and
for each topic search string, searching for stories in the database matching the topic search string.

4. The method of claim 1 wherein said step of displaying further comprises displaying according to at least one of the following: the first theme name and the at least one more theme name, the plurality of topic names, a date, a range of dates, and a geographical location.

5. The method of claim 3 wherein said step of displaying further comprises displaying according the first theme name and the at least one more theme name.

6. The method of claim 3 wherein said step of displaying a single web page comprises:
displaying one theme name of one of the first theme name and the at least one more theme name;
displaying a menu of theme names of the first theme name and the at least one more theme name;
for each topic name of the one theme name,
displaying the topic name of the one theme name; and
displaying with each topic name at least some of the matching stories.

7. The method of claim 6 further comprising:
selecting a different one of the theme names of the menu; and
for the selected theme name, displaying a new single web page by repeating said steps of displaying the one theme name, displaying the menu of theme names, displaying the topic name, and displaying with each topic name.

8. The method of claim 3 wherein said step of displaying comprises:
for each theme name of the first theme name and at least one more theme name, and in a separate area of the single web page,
displaying the each theme name; and
displaying with the each theme name at least some of the matching stories.

9. The method of claim 8 wherein said step of displaying includes displaying the plurality of topic names for the each theme name.

10. The method of claim 8 wherein said step of displaying further comprises displaying a sub-menu of theme names of the first theme name and the at least one more theme name.

11. The method of claim 8 wherein said step of displaying further comprises displaying a thumbnail image.

12. The method of claim 3 wherein said step of displaying comprises displaying a menu of theme names of the first theme name and the at least one more theme name.

13. The method of claim 1 wherein said displaying at least some of the stories further comprises displaying a title for at least some of the stories.

14. The method of claim 1 wherein said displaying at least some of the stories further comprises displaying a source for at least some of the stories.

15. The method of claim 1 wherein said displaying at least some of the stories further comprises displaying a summary for at least some of the stories.

16. The method of claim 1 wherein said step of displaying further comprises displaying as an embedded link.

17. A method for organizing and displaying stories by themes comprising the steps of:
providing a database of stories;
creating a first theme name and at least one more theme name;
choosing a plurality of topic names for the first theme name and the at least one more theme name;
for each topic name, creating a topic search string;
for each topic search string, searching for stories in the database matching the topic search string; and
displaying at least some of the matching stories as a single web page wherein said displaying comprises,
displaying a menu of theme names of the first theme names and the at least one more theme name; and
displaying at least some of the first theme name, the at least one more theme name, the plurality of topic names, and the matching names according to at least one of the following: the first theme name and the at least one more theme name, the plurality of topic names, a date, a range of dates, and a geographical location.

18. A computer program product for organizing and displaying stories by themes, the program product comprising:
a computer readable medium;
a database of stories stored on said computer readable medium;
means for creating a theme name stored on said computer readable medium;
means for choosing a plurality of topic names for the theme name stored on said computer readable medium;
means for creating a topic search string for the topics names stored on said computer readable medium;
means for searching the database for stories matching the topic search string stored on said computer readable medium; and
means for displaying the matching stories as a single web page stored on said computer readable medium.
